(19) United States
(12) Patent Application Publication
(10) Pub. No.: US 2025/0063398 A1
(43) Pub. Date: Feb. 20, 2025

(54) SYSTEM ANDMETHOD FOR IDENTIFYING UTILIZATION OF LOW TELECOM SERVICES IN A PREDEFINED AREA

(71) Applicant: JIO PLATFORMS LIMITED, Ahmedabad (IN)

(72) Inventors: Ajay Kumar GUPTA, Pune (IN); Rajeshwari V, Bengaluru (IN); Sundaresh SANKARAN, Mumbai (IN); Aayush BHATNAGAR, Navi Mumbai (IN)

(21) Appl. No.: 18/029,680

(22) PCT Filed: Mar. 16, 2023
(86) PCT No.: PCT/IB2023/052578

§ 371 Date: Mar. 31, 2023

(30) Foreign Application Priority Data
Mar. 30, 2022 (IN) 202221018947

(51) Int. Cl. H04W 24/08; H04L 41/5009

(52) U.S. Cl. CPC H04W 24/08; H04L 41/5009

(57) ABSTRACT

The present invention provides system and method for identifying utilization of low telecom services in predefined area. System receives data pertaining to set of one or more telecom sites operating in predefined area from user. Further, system divides each of telecom sites into one or more spatial grids, where telecom sites includes one or more macro sites and at least one sector. System generates at least one spatially tagged measurement sample by call log server, which includes start and end time of each of calls and data sessions of subscribers associated with macro sites. Finally, system marks one or more spatial grids as low utilized based on pre-determined condition, and clusters neighbouring low utilized spatial grids in predefined area to generate large clusters of low utilized grids representing of low telecom utilization.

### RESERVATION OF RIGHTS

A portion of the disclosure of this patent document contains material which is subject to intellectual property rights such as, but are not limited to, copyright, design, trademark, integrated circuit (IC) layout design, and/or trade dress protection, belonging to Jio Platforms Limited (JPL) or its affiliates (herein after referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The embodiments of the present disclosure generally relate to telecommunication deployment. More particularly, the present disclosure relates to systems and methods for identifying utilization of low telecom services in a predefined area.

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

Telecom operators generally designate a circular area of certain radius, around a low utilized Telecom Site, as low utilization area or a low utilized site based on one or more Key Performance Indicator (KPIs) of that site. However, this coarse approach does not accurately mark the low utilization areas since each of the site contains of multiple sectors and each sector consists of multiple cells, and therefore it may happen that although a site may be underutilized by a certain factor altogether, but certain sectors or certain cells within a sector are optimally utilized. Further, a particular area, falling under the overlapping telecom coverage, could be served by different sites, and hence declaring a circular area as under-utilized based on a Low utilized site at a center does not accurately point out the accurate depiction of low utilization areas. There is no known method to accurately predict the areas of low telecom utilization. There is no known method to accurately predict the areas of low telecom utilization.

Therefore, there is a need in the art to provide systems and methods that can overcome the shortcomings of the existing prior art and can accurately identify one or more low utilization areas.

### OBJECTS OF THE PRESENT DISCLOSURE

Some of the objects of the present disclosure, which at least one embodiment herein satisfies are as listed herein below.

An object of the present disclosure is to provide a system and methods that helps telecom operators to accurately identify the spatial clusters or areas of low utilization of telecom assets being deployed to serve the subscribers in those areas.

An object of the present disclosure is to provide a system and methods that identifies spatial clusters of low utilization so that the telecom operators can be directed to grow the subscriber's numbers without deteriorating the customer experience of telecom services.

An object of the present disclosure is to provide a system and methods that helps operators to identify low utilization areas based on morphology constraints, meaning low utilization areas can be identified separately for dense urban, urban, rural morphologies.

An object of the present disclosure is to provide a system and methods that helps operators to target specific morphologies in a priority order. For example, each operator would like to prioritize for dense urban morphology based low utilization areas.

An object of the present invention is to optimize the cost of network operators.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure provides a system for identifying utilization of low telecom services in a predefined area. The system includes one or more processors coupled with a memory. The memory stores instructions which when executed by the one or more processors causes the system to receive data pertaining to a set of one or more telecom sites operating in the predefined area from a user. Further, the system may be configured to divide each of the one or more telecom sites into one or more spatial grids, where the one or more telecom sites includes one or more macro sites and at least one sector. Furthermore, the system may be configured to generate at least one spatially tagged measurement sample by a call log server. The at least one spatially tagged measurement sample may include a start time and an end time of each of one or more calls and data sessions of one or more subscribers associated with the one or more macro sites. Finally, the system may be configured to mark the one or more spatial grids as low utilized based on a pre-determined condition. Additionally, the system may be configured to cluster at least one neighbouring low utilized spatial grids in the predefined area to generate one or more large clusters of low utilized grids representing low telecom utilization.

In an embodiment, the system may be configured to compute a list of at least one low utilized sector of the one or more telecom sites operating in the predefined area based on at least one or more Key Performance Indicators (KPIs) associated with Physical Resource Blocks (PRBs).

In an embodiment, the system may be configured to map each of the at least one spatially tagged measurement sample to the one or more spatial grids. Further, the system may be configured to calculate a list of unique sectors for each of the one or more spatial grids based on the mapped at least one spatially tagged measurement sample. Finally, the system may compare the list of unique sectors of the one or more spatial grids with the list of at least one low utilized sector to obtain one or more low utilized spatial grids.

In an embodiment, the pre-determined condition for marking the one or more spatial grids as low utilized is based on at least one non-zero sector being part of the at least one of the list of unique sectors of the one or more spatial grids, and the list of at least one low utilized sector of the one or more telecom sites operating in the predefined area.

In an embodiment, the system may be configured to compute one or more parameters for each of the cluster by aggregating data across the one or more spatial grids which forms the part of each of the clusters.

In an embodiment, the system may be configured to computing the list of at least one low utilized sector based on a set of pre-conditions including percentage of the at least one spatially tagged measurement sample being mapped to the one or more spatial grids of the at least one sector being part of a grid sector list, where the overall list of at least one low utilized sector for the predefined area is above a pre-determined threshold.

In an embodiment, Key Performance Indicators (KPIs) may be computed for the at least one sector which includes at least one of Physical Resource Blocks (PRBs), a number of active subscribers, Average Revenue Per User (ARPU), gross additions and disconnections.

In an embodiment, the system may be configured to compare an average PRB utilization and a predefined PRB utilization threshold to provide an inference of the list of at least one low utilized sector. The average PRB utilization may be computed for the at least one sector during busy hour of a day. The predefined PRB utilization may be computed for the at least one sector consistently remains below aa pre-defined threshold for at least a first number of days out of a second number days, the corresponding cell is marked as being low utilized.

In an embodiment, the system may be configured to generate at least one cluster for the list of low utilized sectors by calculating at least one parameter of cluster by aggregating a unique dominant sector ID across the one or more spatial grids forming the part of the cluster.

In an embodiment, the at least one spatially tagged measurement sample provides values of spatial location including at least one of a latitude and longitude, a customer identifier, an International Mobile Subscriber Identity (IMSI), a serving cell identifier (CELLID), and a Reference Signal Received Power (RSRP) value.

In an embodiment, the predefined area of the system may be filtered based on a predefined list of expected morphologies, includes at least one of an urban, a semi-urban, a rural, and a highway.

In an embodiment, the user of the system may be a network administrator, a subscriber, and a network operator.

In an aspect, the present disclosure relates to a User Equipment (UE) operating in a low telecom service area. The UE may include one or more processors coupled with a memory, where said memory stores instructions which when executed by the one or more processors causes the UE to transmit data pertaining to a set of one or more telecom sites operating in a predefined area to a system. Further, the UE may execute one or more instructions pertaining to a response received from the system corresponding to the one or more telecom sites.

In an aspect, the present disclosure relates to a method for identifying utilization of low telecom services in a predefined area. The method includes the step of receiving data, by the system, pertaining to a set of one or more telecom sites operating in the predefined area from a user. Further, the method includes the step of dividing, by the system, each of the one or more telecom sites into one or more spatial grids, where the one or more telecom sites includes one or more macro sites and at least one sector. Furthermore, the method includes the step of generating, by the system, at least one spatially tagged measurement sample by a call log server. The at least one spatially tagged measurement sample may include a start time and an end time of each of one or more calls and data sessions of one or more subscribers associated with the one or more macro sites. Finally, the method includes the step of marking, by the system, the one or more spatial grids as low utilized based on a pre-determined condition, and clustering at least one neighbouring low utilized spatial grids in the predefined area to generate one or more large clusters of low utilized grids representing low telecom utilization.

### BRIEF DESCRIPTION OF DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. It will be appreciated by those skilled in the art that invention of such drawings includes the invention of electrical components, electronic components or circuitry commonly used to implement such components.

FIG. 1 illustrates an exemplary network architecture in which or with which proposed system of the present disclosure can be implemented, in accordance with an embodiment of the present disclosure.

FIG. 2A illustrates an exemplary representation of the proposed system (102) for identifying utilization of low telecom services in a predefined area, in accordance with an embodiment of the present disclosure.

FIG. 2B illustrates an exemplary block diagram representation of a user equipment (UE) (106) for identifying utilization of low telecom services in a predefined area (110), in accordance with an embodiment of the present disclosure.

FIG. 3 illustrates an exemplary flow diagram of a method (300) for computing of low utilized sectors at a certain time in the predefined area, in accordance with an embodiment of the present disclosure.

FIG. 4 illustrates an exemplary representation of a flow diagram of a method (400) for computing low utilized spatial grids at a certain time in the telecom site of the predefined area, in accordance with an embodiment of the present disclosure.

FIG. 5 illustrates an exemplary representation of a flow diagram of a method (500) for identifying larger clusters or areas of low telecom utilization being based on the low utilized grids identified in the telecom site of the predefined area, in accordance with an embodiment of the present disclosure.

FIG. 6 illustrates an exemplary computer system in which or with which embodiments of the present invention can be utilized in accordance with embodiments of the present disclosure.

The foregoing shall be more apparent from the following more detailed description of the invention.

### DETAILED DESCRIPTION OF INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

The present invention provides an efficient and reliable systems and methods that can accurately predict one or more low utilization areas which can be optimally targeted for subscriber's growth. The system and method can enable identification of the one or more areas with low telecom utilization. The one or more identified areas can then be targeted by a telecom operator to push for additional subscriber's growth without deteriorating customer experience, along with ensuring optimum utilization and return on investment (ROI) on one or more deployed telecom assets.

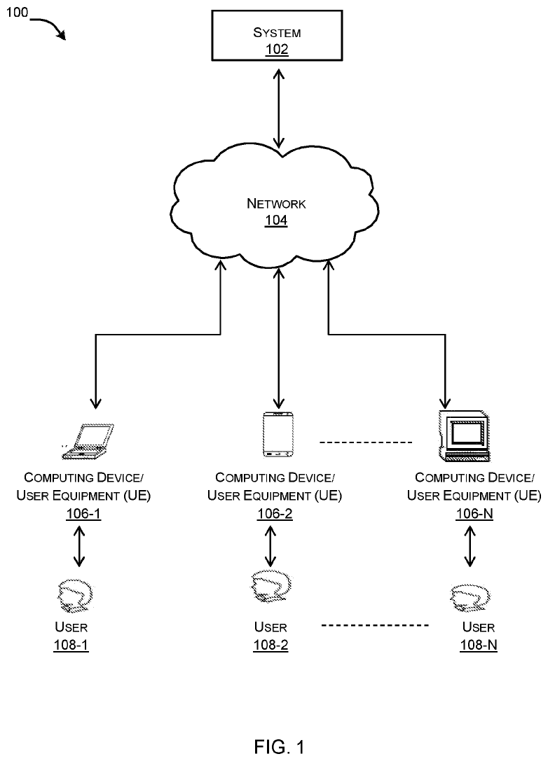

FIG. 1 illustrates an exemplary network architecture in which or with which proposed system of the present disclosure can be implemented, in accordance with an embodiment of the present disclosure.

Referring to FIG. 1 that illustrates an exemplary representation of telecom deployment architecture (100) in a predefined area, in accordance with various aspects of the disclosure. The telecom deployment architecture (100) may include the proposed system (102) with which or in which one or more low utilization sites or cells in the predefined area can be identified. The predefined area may include but not limited to urban, semi-urban, rural, highway, and others.

In an embodiment, but not a limitation, the telecom deployment architecture (100) may include the system (102), a network (104), one or more computing devices/User Equipments (UEs) (106-1, 106-2 . . . 106-N) associated with one or more users (108-1, 108-2 . . . 108-N). A person of ordinary skill in the art will appreciate that the one or more computing devices (106-1, 106-2 . . . 106-N) may be collectively referred as computing devices (106) and individually referred as computing device (106). Similarly, the one or more users (108-1, 108-2 . . . 108-N) may be collectively referred as users (108) and individually referred as user (108). It may be appreciated that the terms “computing device” and “user equipment (UE)” may be used interchangeably throughout the disclosure.

In an embodiment, the user (108) may include, but not be limited to, a network administrator, a network operator, and others. Alternatively, or additionally, the user (108) may include one or more subscribers. The one or more subscribers relate to people who can receive and access the services of a particular network.

In an embodiment, the computing device (106) may include, but not limited to, a handheld wireless communication device (e.g., a mobile phone, a smart phone, a phablet device, and so on), a wearable computer device (e.g., a head-mounted display computer device, a head-mounted camera device, a wristwatch computer device, and so on), a Global Positioning System (GPS) device, a laptop computer, a tablet computer, or another type of portable computer, a media playing device, a portable gaming system, and/or any other type of computer device with wireless communication capabilities, and the like. In an embodiment, the computing devices (106) may communicate with the system (102) via set of executable instructions residing on any operating system. In an embodiment, the computing devices (106) may include, but are not limited to, any electrical, electronic, electro-mechanical or an equipment or a combination of one or more of the above devices such as virtual reality (VR) devices, augmented reality (AR) devices, laptop, a general-purpose computer, desktop, personal digital assistant, tablet computer, mainframe computer, or any other computing device, wherein the computing device may include one or more in-built or externally coupled accessories including, but not limited to, a visual aid device such as camera, audio aid, a microphone, a keyboard, input devices for receiving input from a user (108) such as touch pad, touch enabled screen, electronic pen and the like. It may be appreciated that the computing devices (106) may not be restricted to the mentioned devices and various other devices may be used.

In another embodiment, the telecom deployment architecture (100) in the predefined area may also include one or more macro sites including at least one sector. In an embodiment, the predefined area may be divided into one or more spatial grids of equal area and configurable size.

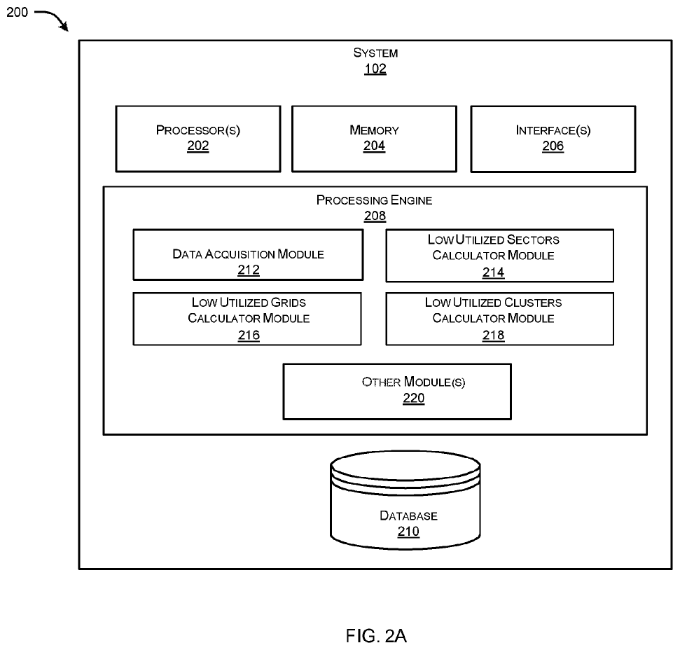

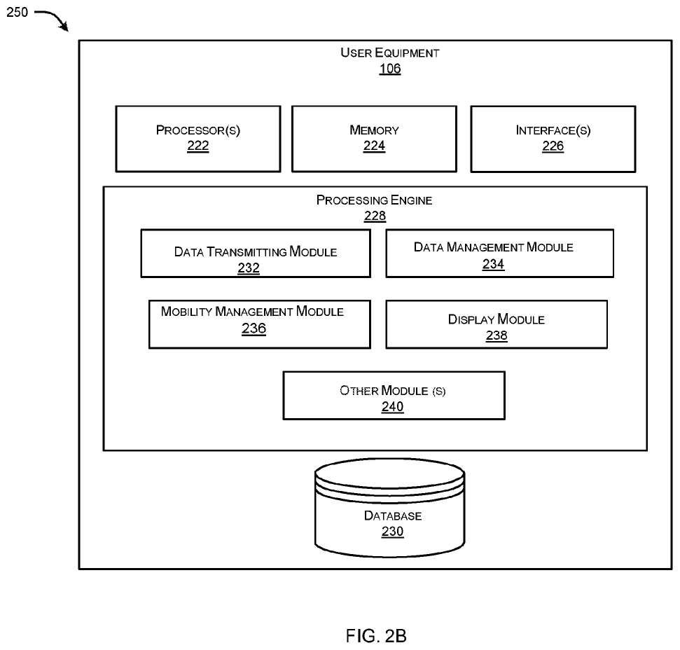

In an embodiment, the proposed system (102) may identify utilization of low telecom services in the predefined area. The system (102) may be equipped with one or more processor (202) (shown in FIG. 2A) that may cause the system (102) to receive data pertaining to a set of one or more telecom sites operating in the predefined area from the user (108). The system (102) may then extract a set of attributes from the set of data or data packets received, where the set of attributes correspond to parameters associated with one or more sectors.

In an embodiment, the system (102) may divide each of the one or more telecom sites into the one or more spatial grids including the one or more macro sites and the at least one sector, respectively. The one or more spatial grids each have a predefined size. Alternatively, filtering of the one or more spatial grids may be based on morphology of the area being represented by the one or more spatial grids.

In an embodiment, the network (104) may be communicatively coupled to at least one call log server (not shown). The call log server may generate at least one spatially tagged measurement sample which includes a start time and an end time of each of one or more calls and data sessions of the one or more subscribers/users (108) associated with the one or more macro sites.

In an embodiment, the network (104) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The network (104) may also include, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof.

In an exemplary embodiment, the system (102) may collect the at least one spatially tagged measurement sample from subscriber's voice and data sessions initiated on the telecom network (104) and then map each of the spatially tagged measurement sample on to the one or more spatial grids. The at least one spatially tagged measurement sample provides values of spatial location in terms of latitude and longitude, customer identifier (IMSI), serving cell identifier (CELLID), Reference Signal Received Power (RSRP) value, and others.

In an embodiment, the system (102) may mark the one or more spatial grids as low utilized based on a pre-determined condition. The pre-conditions may include but not limited to percentage of the at least one spatially tagged measurement sample being mapped to the one or more spatial grids of the at least one sector being part of a grid sector list, where the overall list of at least one low utilized sector for the predefined area is above the pre-determined threshold. In an embodiment, the percentage of total number of mapped samples for the at least one or more sector grids, across low utilized sectors, is then compared against the pre-determined threshold, for example, 70%, the percentage being computed with respect to total number of spatially tagged measurement samples that are available for the at least one sector grids. If the computed percentage exceeds the pre-determine threshold, the at least one sector grid is declared as “Low utilized” grid. Further, the system (102) may cluster at least one neighbouring low utilized spatial grid in the predefined area to generate one or more large clusters of low utilized grids representing low telecom utilization. The cluster for the list of low utilized sectors may be obtained by calculating at least one parameter of cluster and aggregating a unique dominant sector ID across the one or more spatial grids forming the part of the cluster.

In an embodiment, the system (102) may compute a list of at least one low utilized sector of the one or more telecom sites operating in the predefined area based on at least on one or more Key Performance Indicators (KPIs) computed for the at least one sector. The KPIs may include but not limited to Physical Resource Blocks (PRBs), a number of active subscribers, Average Revenue Per User (ARPU), gross additions, disconnections, and others.

In an exemplary embodiment, the system (102) may map each of the at least one spatially tagged measurement sample to the one or more spatial grids. Further, the system (102) may calculate a list of unique sectors using the one or more spatial grids based on mapped spatially tagged measurement sample. Then, the system (102) may compare the list of unique sectors of the one or more spatial grids with the list of at least one low utilized sector to obtain one or more low utilized spatial grids.

In an exemplary embodiment, the system (102) may mark the one or more spatial grids as low utilized on basis of a pre-determined condition being fulfilled by non-zero sector being part of the at least one of the list of unique sectors of the one or more spatial grids, and the list of at least one low utilized sector of the one or more telecom sites operating in the predefined area. Further, the system (102) may be configured to cluster the neighbouring low utilized spatial in the predefined area in order to generate one or more large clusters of low utilized grids. Further, the system (102) may compute one or more parameters for each of the cluster by aggregating data across all the one or more spatial grids which form the part of the cluster. The system (102) may build a concave boundary for each of the cluster to depict each cluster as a spatial area being representative of low telecom utilization.

In an exemplary embodiment, the system (102) may compare an average PRB utilization and a PRB utilization threshold to provide an inference of the list of at least one low utilized sector, where the average PRB utilization is computed for the at least one sector during busy hour of a day. The PRB utilization computed for the at least one sector consistently remains below 50 percent utilization threshold for at least a first number of days out of a second number days, the corresponding cell being marked as being low utilized.

FIG. 2A illustrates an exemplary representation (200) of the proposed system (102) for identifying utilization of low telecom services in a predefined area, in accordance with an embodiment of the present disclosure.

As illustrated, the system (102) may include one or more processors (202) that may be implemented as one or more microprocessors, microcomputers, microcontrollers, digital signal processors, central processing units, logic circuitries, and/or any devices that manipulate data based on operational instructions. Among other capabilities, the one or more processor(s) (202) may be configured to fetch and execute computer-readable instructions stored in a memory (204). The memory (204) may store one or more computer-readable instructions or routines, which may be fetched and executed to create or share the data units over a network service. The memory (204) may comprise any non-transitory storage device including, for example, volatile memory such as RAM, or non-volatile memory such as EPROM, flash memory, and the like.

In an embodiment, the system (102) may comprise an interface(s) (206). The interface(s) (206) may comprise a variety of interfaces, for example, interfaces for data input and output devices, referred to as I/O devices, storage devices, sensors, and the like. The interface(s) (206) may facilitate communication of the computing device (106) with various devices coupled to it. The interface(s) (206) may also provide a communication pathway for one or more components of the system (102). Examples of such components include, but are not limited to, processing engine(s) (208) and database (210).

In an embodiment, the one or more processors (202) may be implemented as a combination of hardware and programming (for example, programmable instructions) to implement one or more functionalities of the one or more processors (202). In examples described herein, such combinations of hardware and programming may be implemented in several different ways. For example, the programming for the one or more processors (202) may be processor-executable instructions stored on a non-transitory machine-readable storage medium and the hardware for the one or more processors (202) may comprise a processing resource (for example, one or more processors), to execute such instructions. In the present examples, the machine-readable storage medium may store instructions that, when executed by the processing resource, implement the one or more processors (202). In such examples, the system (102) may comprise the machine-readable storage medium storing the instructions and the processing resource to execute the instructions, or the machine-readable storage medium may be separate but accessible to the system (102) and the processing resource. In other examples, the one or more processors (202) may be implemented by electronic circuitry.

In an aspect, the database (210) may comprise data that may be either stored or generated as a result of functionalities implemented by any of the components of the processor (202) and/or the processing engines (208). In an embodiment, the database (210) may include data processed by any or all the components of the system (102). As an example but not limitation, the database (210) may include the at least one spatially tagged measurement sample corresponding to the predefined area which are fetched from the telecom core and stored for analysis.

In an exemplary embodiment, the processing engine(s) (208) of the system (102) may include, a data acquisition engine (212), a low utilized sectors calculator module (214), a low utilized grids calculator module (216), a low utilized clusters calculator module (218), and other modules/engines (220), wherein the other modules/engines (220) may further include, without limitation, storage engine, computing engine, or signal generation engine.

In an embodiment, the data acquisition engine (212) may include receiving the data packets from the UE (106) pertaining to the set of one or more telecom sites operating in the predefined area.

In an embodiment, the low utilized sectors calculator module (214) may compute a list of low utilized sectors in accordance with various aspects of the disclosure. In an embodiment, the low utilized sectors calculator module (214) may compute, for each of the at least one sector grids, a total number of mapped samples across all those sectors being part of the mapped spatially tagged measurement sample and are being designated as “Low utilized” sectors after computing the low utilization sectors. The percentage of total number of mapped samples for the at least one or more sector grids, across low utilized sectors, is then compared against a pre-determined threshold, for example 70%, the percentage being computed with respect to total number of mapped spatially tagged measurement sample that is available for the at least one sector grid. If the computed percentage exceeds the threshold, the at least one sector grid is then declared as “Low utilized” grid.

In an embodiment, the low utilized sectors calculator module (214) may calculate the area pertaining to “Low utilized” sector grids which together forms the larger area. The “Low utilized” sector grids are obtained by computing a list of unique “Low utilized” sector grids for each larger area by merging the already computed lists of “Low utilized” sectors grids of each of the “Low utilized” sector grids which together forms the larger area.

In an embodiment, the low utilized grids calculator module (216) may identify larger clusters or areas of low telecom utilization being based on the low utilized grids identified in the telecom site of the predefined area. In an embodiment, the low utilized grids calculator module collects the at least one spatially tagged measurement sample during a certain period from the database (210) and subsequently computes the at least one low utilized sector grids in the predefined area.

In an embodiment, the low utilized clusters calculators module (218) may take the at least one low utilized sector grids computed by the low utilized grids calculator module (216) and then compute larger clusters of low utilization and associated unique sectors with each of the larger cluster in accordance with various aspects of the disclosure.

FIG. 2B illustrates an exemplary block diagram representation of a user equipment (UE) (106) for identifying utilization of low telecom services in a predefined area, in accordance with an embodiment of the present disclosure. In an aspect, the UE (106) may comprise a processor (222). The processor (222) may be an edge-based processor but not limited to it. The processor (222) may be implemented as one or more microprocessors, microcomputers, microcontrollers, digital signal processors, central processing units, logic circuitries, and/or any devices that process data based on operational instructions. Among other capabilities, the processor(s) (222) may be configured to fetch and execute computer-readable instructions stored in a memory (224) of the UE (106). The memory (224) may be configured to store one or more computer-readable instructions or routines in a non-transitory computer readable storage medium, which may be fetched and executed to create or share data packets over a network service. The memory (224) may comprise any non-transitory storage device including, for example, volatile memory such as RAM, or non-volatile memory such as EPROM, flash memory, and the like.

In an embodiment, the UE (106) may include an interface(s) (226). The interface(s) (226) may comprise a variety of interfaces, for example, interfaces for data input and output devices, referred to as I/O devices, storage devices, and the like. The interface(s) (226) may facilitate communication of the UE (106). Examples of such components include, but are not limited to, processing engine(s) (228) and a database (230).

The processing engine(s) (228) may be implemented as a combination of hardware and programming (for example, programmable instructions) to implement one or more functionalities of the processing engine(s) (228). In examples described herein, such combinations of hardware and programming may be implemented in several different ways. For example, the programming for the processing engine(s) (228) may be processor executable instructions stored on a non-transitory machine-readable storage medium and the hardware for the processing engine(s) (228) may comprise a processing resource (for example, one or more processors), to execute such instructions. In the present examples, the machine-readable storage medium may store instructions that, when executed by the processing resource, implement the processing engine(s) (228). In such examples, the UE (106) may comprise the machine-readable storage medium storing the instructions and the processing resource to execute the instructions, or the machine-readable storage medium may be separate but accessible to the UE (106) and the processing resource. In other examples, the processing engine(s) (228) may be implemented by electronic circuitry.

In an aspect, the database (230) may comprise data that may be either stored or generated as a result of functionalities implemented by any of the components of the processor (222) and/or the processing engines (228). Further, the database (230) may comprise the transmitted data packet, the data processed using one or more engines, the computed results, and the like.

In an exemplary embodiment, the processing engine(s) (228) of the user equipment (106) may include, a data transmitting engine (232), a data management engine (234), a mobility management engine (236), a display engine (238), and other engines (240), wherein the other engines (240) may further include, without limitation, storage engine, computing engine, or signal generation engine.

In an embodiment, the data transmitting engine (232) may include the transfer of the data packets in the form of user request over a point-to-point or point-to-multipoint communication channel. The system (102) may receive the data packets, which are transmitted from the UE (106).

In an embodiment, the data management engine (234) may involve the collection, storage, analysis, and sharing of data within the network (104). The UE (106) may be configured to manage the data received from the system (102), where the data may include identifying low sector area, resource sharing, and the like.

In an embodiment, the mobility management module (236) may enable tracking, where the user (106) is allowing calls, SMS and other UE services to be delivered to them.

In an embodiment, the display module (238) may enable presentation of information to the user (108). The system (102) provides low utilized grids representing of low telecom utilization in the predefined area, to the user (108) via UE (106).

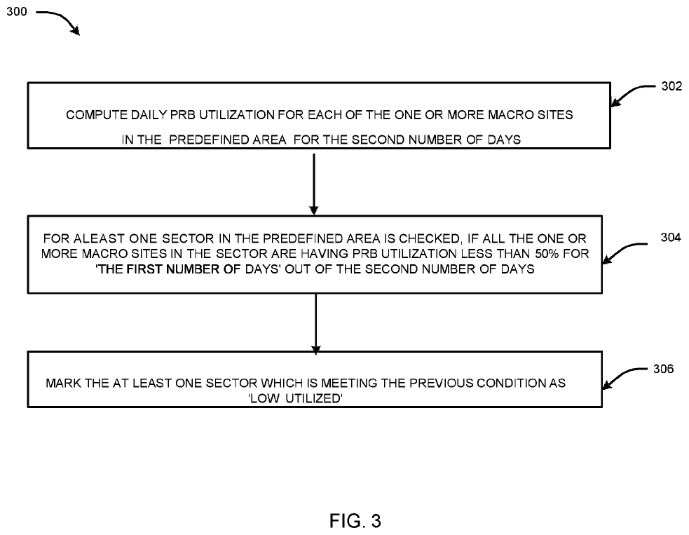

FIG. 3 illustrates an exemplary flow diagram of a method (300) for computing low utilized sectors at a certain time in the predefined area, in accordance with an embodiment of the present disclosure.

In an embodiment, the method (300) may include, at step (302), computing daily PRB utilization for each of the one or more macro sites in the predefined area for a predefined time. In an embodiment, the PRB usage ratio pertains to managing the Quality of Service (QOS). As the PRB usage ratio increases, the resource may not be allocated in a timely and reliable manner to the users of the cell. Thus, the PRB utilization for each of the one or more macro sites in the predefined area has to be mapped to a predefined time. For example, the subscribers in “x” predefined area are using “y” services from “the second number of days.”

In an embodiment, at step (304), the method may include iterating each of the sector in the predefined area to check whether the one or more macro sites in an iterated sector are having PRB utilization less than predefined percentage for at least the first predefined time out of the predefined time. In an exemplary embodiment, when the PRB utilization is less than 50% for “the first number of days” out of “the second number of days,” then the iteration terminates.

In an embodiment, during the iteration, if any of the sector satisfies the condition, at step (306), the method may include marking the same as one of “Low utilized” sector in the predefined area. Once the iteration completes, a list of low utilized sectors is available for the predefined area.

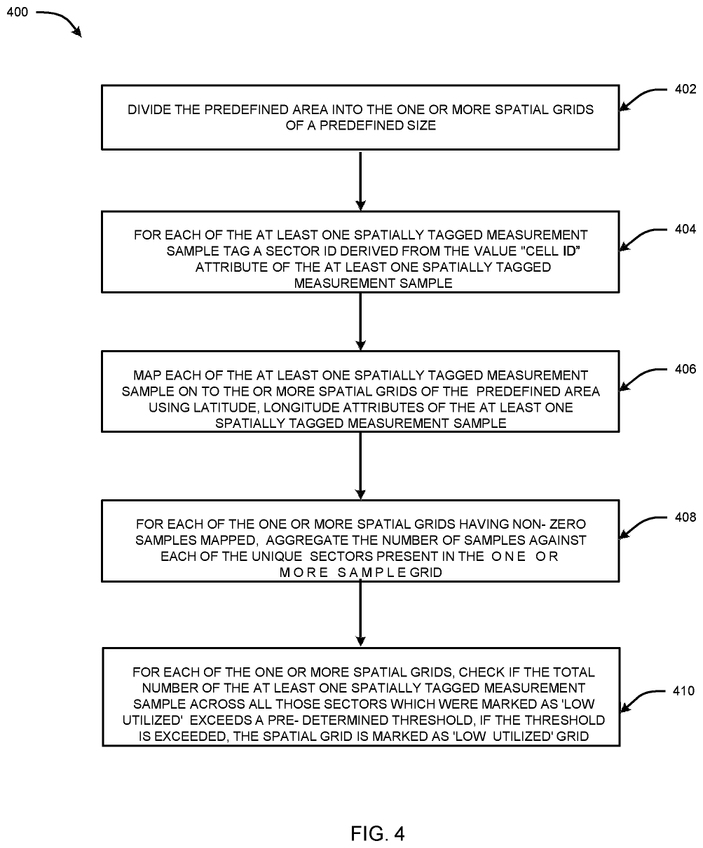

FIG. 4 illustrates an exemplary representation of a flow diagram of a method (400) for computing low utilized spatial grids at a certain time in the telecom site of the predefined area, in accordance with an embodiment of the present disclosure.

In an embodiment, the method (400) may include, at step (402), dividing the predefined area into the one or more spatial grids, for example, rectangular grids of equal size, 50*50 meters. Alternatively, or additionally, the one or more spatial grids may be filtered based on one or more morphology constraints, such as when there is a requirement to find only low utilized areas in urban areas only, the grids having urban morphology shall be taken forward for low utilization computation.

In another embodiment, the method (400) may further include at step (404), collecting the at least one spatially tagged measurement sample over a given time period, for example “the second number of days.” The time period may be tagged with a sector identifier being derived from the cell identifier attribute present in each of the at least one spatially tagged measurement sample. Subsequently, at step (406), the method may include mapping each of the at least one spatially tagged measurement sample to one of the at least one sector grids that are being considered for low utilization computation at step (402). The mapping is being done using the latitude and longitude attributes being present in each of the at least one spatially tagged measurement sample. In case, the at least one spatially tagged measurement sample cannot be mapped to any of the at least one sector grids under consideration, the same is discarded for any further computation.

In an embodiment, the method (400) may further include at step (408), performing aggregation for each of the at least one sector grids, with non-zero mapped samples, to count the number of mapped the at least one spatially tagged measurement sample against each of the unique sectors being part of the mapped samples. After the aggregation, at step (410), the method may include computing for each of the at least one sector grids, total number of mapped samples across all those sectors being part of the mapped at least one spatially tagged measurement sample and are being designated as “Low utilized” sectors after the algorithm for computing the low utilization sectors, as depicted in FIG. 3, has already been executed. The percentage of total number of mapped samples for the at least one or more sector grids, across low utilized sectors, is then compared against a pre-determined threshold, for example 70%, the percentage being computed with respect to total number of mapped the at least one spatially tagged measurement sample that is available for the at least one sector grids. If the computed percentage exceeds the threshold, the at least one sector grid is then declared as “Low utilized” grid.

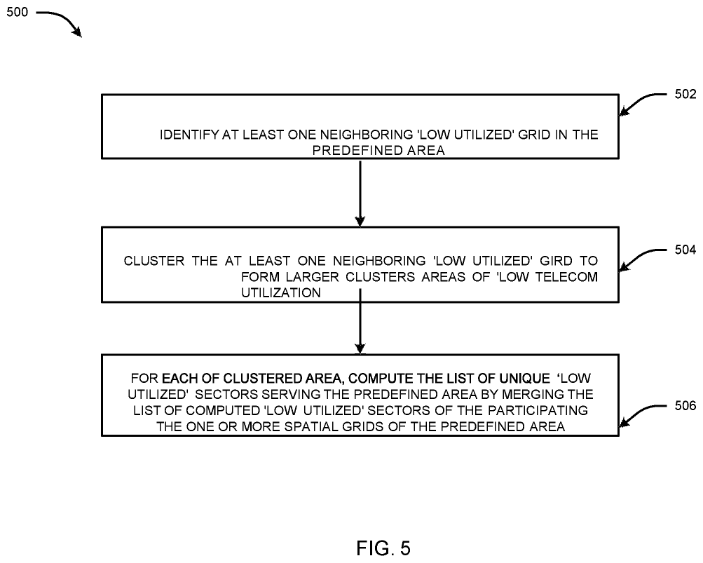

FIG. 5 illustrates an exemplary representation of a flow diagram of a method (500) for identifying larger clusters or areas of low telecom utilization being based on the low utilized grids identified in the telecom site of the predefined area, in accordance with an embodiment of the present disclosure.

In an embodiment, the method (500) may include at step (502), identifying the at least one neighbouring “Low utilized” spatial grids. At step (504), the method may include drawing a concave boundary around the non-neighbouring boundaries of all the grids belonging to the neighbouring group, and for each of the identified neighbouring group, a cluster is identified. Once the larger areas of “Low utilization” are identified, at step (506), the method may include computing a list of unique “Low utilized” sector grids for each of the larger area by merging the already computed lists of “Low utilized” sectors grids of each of the “Low utilized” sector grids which together forms the larger area.

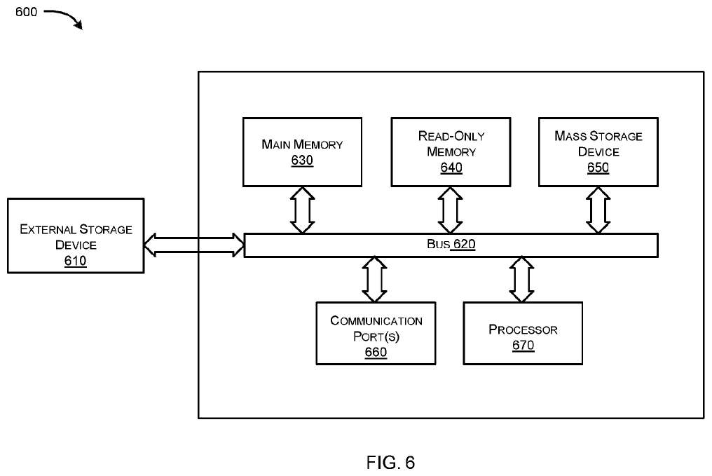

FIG. 6 illustrates an exemplary computer system (600) in which or with which embodiments of the present disclosure can be utilized in accordance with embodiments of the present disclosure.

As shown in FIG. 6, computer system (600) may include an external storage device (610), a bus (620), a main memory (630), a read only memory (640), a mass storage device (650), communication port(s) (660), and a processor (670). A person skilled in the art will appreciate that the computer system (600) may include more than one processor and communication ports. The processor (670) may include various modules associated with embodiments of the present disclosure. The communication port(s) (660) may be any of an RS-232 port for use with a modem based dialup connection, a 10/100 Ethernet port, a Gigabit or 10 Gigabit port using copper or fibre, a serial port, a parallel port, or other existing or future ports. The communication port(s) (660) may be chosen depending on a network, or any network to which computer system (600) connects. The main memory (630) may be Random Access Memory (RAM), or any other dynamic storage device commonly known in the art. The read-only memory (640) may be any static storage device(s). The mass storage device (650) may be any current or future mass storage solution, which can be used to store information and/or instructions.

The bus (620) communicatively couples the processor(s) (670) with the other memory, storage, and communication blocks. Optionally, operator and administrative interfaces, e.g. a display, keyboard, and a cursor control device, may also be coupled to the bus (620) to support direct operator interaction with the computer system (600). Other operator and administrative interfaces can be provided through network connections connected through communication port(s) (660). Components described above are meant only to exemplify various possibilities. In no way should the aforementioned exemplary computer system limit the scope of the present disclosure.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

### Advantages of the Present Disclosure

The present disclosure provides a unique, efficient system and method that helps telecom operators to accurately identify the spatial clusters or areas of low utilization of telecom assets being deployed to serve the subscribers in those areas.

The present disclosure identifies of spatial clusters of low utilization helps telecom operators to direct the dedicated marketing campaigns in the identified clusters in order to grow the subscriber's numbers without deteriorating the subscriber experience of telecom services.

The present disclosure helps operators to identify low utilization areas based on morphology constraints, meaning low utilization areas can be identified separately for dense urban, urban, rural morphologies. This would subsequently help operators to target specific morphologies in a priority order. For example, each operator would like to prioritize for dense urban morphology based low utilization areas.

The present disclosure facilitates operators to target specific morphologies in a priority order. For example, each operator would like to prioritize for dense urban morphology based low utilization areas.

We claim:

1. A system (102) for identifying utilization of low telecom services in a predefined area, the system (102) comprising:
one or more processors (202) coupled with a memory (204), wherein said memory (204) stores instructions which when executed by the one or more processors (202) causes the system (102) to:
receive data packets pertaining to a set of one or more telecom sites operating in the predefined area from a user (108);
divide each of the one or more telecom sites into one or more spatial grids, wherein the one or more telecom sites comprise one or more macro sites and at least one sector;
generate at least one spatially tagged measurement sample by at least one call log server, wherein the at least one spatially tagged measurement sample comprises a start time and an end time of each of one or more calls and data sessions of one or more subscribers associated with the one or more macro sites; and
mark the one or more spatial grids as low utilized based on a pre-determined condition, and cluster at least one neighbouring low utilized spatial grid in the predefined area to generate one or more large clusters of low utilized grids representing low telecom utilization.

2. The system (102) as claimed in claim 1, wherein the system (102) is configured to:
compute a list of at least one low utilized sector of the one or more telecom sites operating in the predefined area based on at least one or more Key Performance Indicators (KPIs) associated with Physical Resource Blocks (PRBs).

3. The system (102) as claimed in claim 1, wherein the system (102) is configured to:
map each of the at least one spatially tagged measurement sample to the one or more spatial grids;
calculate a list of unique sectors for each of the one or more spatial grids based on the mapped at least one spatially tagged measurement sample; and
compare the list of unique sectors of the one or more spatial grids with the list of at least one low utilized sector to obtain one or more low utilized spatial grids.

4. The system (102) as claimed in claim 1, wherein the pre-determined condition is based on at least one non-zero sector being part of the at least one of the list of unique sectors of the one or more spatial grids, and the list of at least one low utilized sector of the one or more telecom sites operating in the predefined area.

5. The system (102) as claimed in claim 1, wherein the system (102) is configured to:
compute one or more parameters for each of the cluster by aggregating data across the one or more spatial grids which forms the part of each of the clusters.

6. The system (102) as claimed in claim 1, wherein the system (102) is configured to:
compute the list of at least one low utilized sector based on a set of pre-conditions comprising percentage of the at least one spatially tagged measurement sample being mapped to the one or more spatial grids of the at least one sector being part of a grid sector list, wherein the overall list of at least one low utilized sector for the predefined area is above a pre-determined threshold.

7. The system (102) as claimed in claim 2, wherein the Key Performance Indicators (KPIs) computed for the at least one sector comprises at least one of Physical Resource Blocks (PRBs), a number of active subscribers, an Average Revenue Per User (ARPU), and gross additions and disconnections.

8. The system (102) as claimed in claim 1, wherein the system (102) is configured to:
compare an average Physical Resource Block (PRB) utilization and a predefined PRB utilization threshold to provide an inference of the list of at least one low utilized sector, wherein the average PRB utilization is computed for the at least one sector during busy hour of a day, and wherein if the predefined PRB utilization computed for the at least one sector consistently remains below a pre-defined threshold for at least a first number of days out of a second number days, the corresponding cell is marked as being low utilized.

9. The system (102) as claimed in claim 1, wherein the system (102) is configured to:
generate the cluster for the list of low utilized sectors by calculating at least one parameter of cluster by aggregating a unique dominant sector ID across the one or more spatial grids forming the part of the cluster.

10. The system (102) as claimed in claim 1, wherein the at least one spatially tagged measurement sample provides values of spatial location comprising at least one of a latitude and longitude, a customer identifier (IMSI), a serving cell identifier (CELLID), and a Reference Signal Received Power (RSRP) value.

11. The system (102) as claimed in claim 1, wherein the predefined area is filtered based on a predefined list of expected morphologies comprises at least one of an urban, a semi-urban, a rural, and a highway.

12. The system (102) as claimed in claim 1, wherein the user (108) is at least one of a network administrator, a network operator, and a subscriber.

13. A User Equipment (UE) (106) operating in a low telecom service area, the UE (106) comprising:
one or more processors (222) coupled with a memory (224), wherein said memory (224) stores instructions which when executed by the one or more processors (222) causes the UE (106) to:
transmit data pertaining to a set of one or more telecom sites operating in a predefined area to a system (102); and
execute one or more instructions pertaining to a response received from the system (102) corresponding to the one or more telecom sites.

14. A method for identifying utilization of low telecom services in a predefined area, the method comprising:
receiving data, by a system (102), pertaining to a set of one or more telecom sites operating in the predefined area from a user (108);
dividing, by the system (102), each of the one or more telecom sites into one or more spatial grids, wherein the one or more telecom sites comprises one or more macro sites and at least one sector;
generating, by the system (102), at least one spatially tagged measurement sample by at least one call log server, wherein the at least one spatially tagged measurement sample comprises a start time and an end time of each of one or more calls and data sessions of one or more subscribers associated with the one or more macro sites; and
marking, by the system (102), the one or more spatial grids as low utilized based on a pre-determined condition, and clustering at least one neighbouring low utilized spatial grids in the predefined area to generate one or more large clusters of low utilized grids representing low telecom utilization.

15. The method as claimed in claim 14, wherein the method further comprises the step of:
computing, by the system (102), a list of at least one low utilized sector of the one or more telecom sites operating in the predefined area based on at least one or more Key Performance Indicators (KPIs) associated with Physical Resource Blocks (PRBs).

16. The method as claimed in claim 14, wherein the method further comprises the step of:
mapping, by the system (102), each of the at least one spatially tagged measurement sample to the one or more spatial grids;
calculating, by the system (102), a list of unique sectors for each of the one or more spatial grids based on the mapped at least one spatially tagged measurement sample; and
comparing, by the system (102), the list of unique sectors of the one or more spatial grids with the list of at least one low utilized sector to obtain one or more low utilized spatial grids.

17. The method as claimed in claim 14, wherein the pre-determined condition is based on at least one non-zero sector being part of the at least one of the list of unique sectors of the one or more spatial grids, and the list of at least one low utilized sector of the one or more telecom sites operating in the predefined area.

18. The method as claimed in claim 14, wherein the method further comprises the step of:
computing, by the system (102), one or more parameters for each of the cluster by aggregating data across the one or more spatial grids which forms the part of each of the clusters.

19. The method as claimed in claim 14, wherein the method further comprises the step of:
computing, by the system (102), the list of at least one low utilized sector based on a set of pre-conditions comprising percentage of the at least one spatially tagged measurement sample being mapped to the one or more spatial grids of the at least one sector being part of a grid sector list, wherein the overall list of at least one low utilized sector for the predefined area is above a pre-determined threshold.

20. The method as claimed in claim 15, wherein the Key Performance Indicators (KPIs) computed for the at least one sector comprises at least one of Physical Resource Blocks (PRBs), a number of active subscribers, an Average Revenue Per User (ARPU), and gross additions and disconnections.

21. The method as claimed in claim 14, wherein the method further comprises the step of:
comparing, by the system (102), an average Physical Resource Block (PRB) utilization and a predefined PRB utilization threshold to provide an inference of the list of at least one low utilized sector, wherein an average PRB utilization is computed for the at least one sector during busy hour of a day, and wherein if the predefined PRB utilization computed for the at least one sector consistently remains below utilization pre-defined threshold for at least a first number of days out of a second number days, the corresponding cell is marked as being low utilized.

22. The method as claimed in claim 14, wherein the method further comprises the step of:
generating, by the system (102), at least one cluster for the list of low utilized sectors by calculating at least one parameter of cluster by aggregating a unique dominant sector ID across the one or more spatial grids forming the part of the cluster.

23. The method as claimed in claim 14, wherein the at least one spatially tagged measurement sample provides values of spatial location comprising at least one of a latitude and longitude, a customer identifier (IMSI), a serving cell identifier (CELLID), and a Reference Signal Received Power (RSRP) value.

24. The method as claimed in claim 14, wherein the predefined area is filtered based on a predefined list of expected morphologies comprising at least one of an urban, a semi-urban, a rural, and a highway.

25. The method as claimed in claim 14, wherein the user (108) is at least one of a network administrator, a network operator, and a subscriber.

26. A non-transitory computer readable medium comprising machine executable instructions that are executable by a processor to:
receive data packets pertaining to a set of one or more telecom sites operating in a predefined area from a user (108);
divide each of the one or more telecom sites into one or more spatial grids, wherein the one or more telecom sites comprises one or more macro sites and at least one sector;
generate at least one spatially tagged measurement sample by at least one call log server, wherein the at least one spatially tagged measurement sample comprises a start time and an end time of each of one or more calls and data sessions of one or more subscribers associated with the one or more macro sites; and
mark the one or more spatial grids as low utilized based on a pre-determined condition, and cluster at least one neighbouring low utilized spatial grids in the predefined area to generate one or more large clusters of low utilized grids representing low telecom utilization.
